(19) United States
(12) Patent Application Publication
(10) Pub. No.: US 2014/0007778 A1
(43) Pub. Date: Jan. 9, 2014

(54) OUTDOOR COOKING APPARATUS

(71) Applicants: Christopher L. Marks, Independence, MO (US); Jerome E. Bublitz, Marshall, MO (US)

(72) Inventors: Christopher L. Marks, Independence, MO (US); Jerome E. Bublitz, Marshall, MO (US)

(73) Assignee: ACE OF HEARTS BBQ SPECIALTIES, LLC, NORTH KANSAS CITY, MO (US)

(21) Appl. No.: 13/541,317

(22) Filed: Jul. 3, 2012

(51) Int. Cl. A47J 37/07; A23B 4/052

(52) U.S. Cl. 99/339; 99/480; 99/482; 126/25 R

(57) ABSTRACT

An outdoor cooking apparatus having an indirect cooking chamber joined to and extending upward and rearward from a direct cooking chamber. A damper is operable to regulate fluid flow between the cooking chambers. Preferably, the cooking apparatus is operable for installation into an outdoor structure, and a flange is joined to at least one of the cooking chambers for engaging the structure and supporting the cooking chambers. Preferably, the indirect cooking chamber includes first and second doors that are rotatable about an approximately vertical axis for accessing an interior of the chamber, and a plurality of vertically spaced shelves are supported within the chamber. The shelves may be vertically adjustable. The direct cooking chamber preferably has a lid that is operable to lock when it is in an open position.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention is directed toward an outdoor cooking apparatus, and in particular, to an outdoor cooking apparatus having direct and indirect cooking chambers.

2. Description of Related Art

There are many different types of cookers, such as smokers and grills, for cooking food outdoors. Smokers are typically used for relatively low heat slow cooking, while grills are typically used for relatively high heat cooking. Most types of conventional smokers have a “firebox,” or a housing for containing fuel such as charcoal and wood, that is fluidly connected to a “smokebox,” or a housing for containing food to be cooked. Typically, there is a damper for regulating the rate at which hot air and smoke can flow from the firebox to the smokebox.

Outdoor kitchens featuring countertops with drop-in grills have become very popular. Most smokers are stand-alone units that are not configured for drop-in mounting in an outdoor kitchen. One commercially available smoker is operable for drop-in mounting within an outdoor kitchen. The smoker includes a firebox, a smokebox that extends above the firebox, and a flange for supporting the smoker on a countertop of the outdoor kitchen. The firebox may be used for high heat grilling at the same time that the smokebox is used for low heat slow cooking. The smokebox has a first shelf for holding food and a horizontally hinged lid for access. An optional add-on shelf may be used to increase the available food holding surface area. The add-on shelf has legs which are supported by the first shelf and a horizontal surface that is spaced a fixed distance from the first shelf. The smoker operates well for its intended purpose, but has limited cooking volume and limited versatility when simultaneously slow cooking a variety of different types of food.

### BRIEF SUMMARY OF THE INVENTION

The present invention is directed toward an outdoor cooking apparatus having a direct cooking chamber and an indirect cooking chamber that is joined to and extends upward and rearward from the entire length of the direct cooking chamber. Preferably, the direct cooking chamber is operable to house burning fuel, such as charcoal and/or wood, for heating the cooking chambers. Preferably, the direct cooking chamber may be used for high heat cooking such as grilling, and the indirect cooking chamber may be used simultaneously as a smoker and/or convection oven for lower heat slow cooking. A damper is operable to regulate fluid flow between the direct and indirect cooking chambers for controlling the temperature within the indirect cooking chamber.

In one embodiment, the outdoor cooking apparatus is operable for drop-in installation into an outdoor structure. A flange is joined to at least one of the direct and indirect cooking chambers for engaging the outdoor structure and supporting the cooking chambers. The indirect cooking chamber has first and second side walls each joined with top and rear walls. The joined walls present an opening opposite the rear wall. First and second doors are rotatably joined to the first and second walls such that the doors are rotatable about an approximately vertical axis. A plurality of vertically spaced shelves are supported by the walls of the indirect cooking chamber for holding food to be cooked within the chamber. The indirect cooking chamber extends upward from the rear of the direct cooking chamber and has a plurality of vertically spaced shelves to increase the available volume for cooking within the indirect cooking chamber while permitting the cooking apparatus to have a relatively small footprint, or width and depth, such that the cooking apparatus takes up a small amount of countertop space relative to its overall cooking volume. The approximately vertically hinged doors allow a user to open and close the doors without extending his or her arm vertically upward beyond his or her reach. The configuration of the cooking apparatus preferably allows an adult of average height to easily access the direct and indirect cooking chambers without getting burned from the hot surfaces.

Another embodiment of cooking apparatus includes at least one vertically adjustable shelf positioned within the indirect cooking chamber. The adjustable shelf allows a user to cook different types of food within the indirect cooking chamber and maximize the available shelf surface area for cooking that food. Preferably, there is more than one vertically adjustable shelf within the indirect cooking chamber. If a relatively low height food is being cooked at the same time as a food having greater height, the shelves may be adjusted relative to each other so that there is more available cooking volume above one of the shelves for cooking the taller food.

In an additional embodiment of cooking apparatus in accordance with the present invention, the direct cooking chamber has a lid configured to be removably locked in an up or open position. The locked position of the lid prevents the lid from inadvertently closing when opened and allows a user to access the direct cooking chamber without needing to actively hold the lid open. Preferably, the direct cooking chamber has first and second side walls and the lid is rotatably joined to the side walls for providing access to the direct cooking chamber. The lid includes first and second holes that are aligned with first and second slots in the side walls. First and second fasteners are received by the aligned first and second holes and first and second slots, respectively. When the lid is in the open position, the first and second fasteners are moveable within the first and second slots between a locked position, in which the lid engages a protrusion joined to one of the side walls to prevent the lid from moving to a closed position, and an unlocked position, in which the lid is moveable to its closed position.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of an outdoor cooking apparatus in accordance with the present invention;

FIG. 2 is a front view of the outdoor cooking apparatus shown in FIG. 1 with doors of an indirect cooking chamber in an open position;

FIG. 3 is a front view showing a lid of a direct cooking chamber in an open position and an ash pan in an open position;

FIG. 4 is a side view of the outdoor cooking apparatus;

FIG. 5 is a cross-sectional side view of the outdoor cooking apparatus;

FIG. 6 is a partial cross-sectional side view showing the direct cooking chamber lid in its open position;

FIG. 7 is a detail view of an adjustable shelf of the outdoor cooking apparatus;

FIG. 8 is a perspective view of an adjustable shelf bracket of the outdoor cooking apparatus;

FIG. 9 is a partial top plan view showing a shelf lock of the outdoor cooking apparatus;

FIG. 10 is a detail view of a vent and valve of the outdoor cooking apparatus;

FIG. 11 is a detail view of an ash pan lock of the outdoor cooking apparatus;

FIG. 12 is a cross-sectional view taken through the line 12-12 in FIG. 1;

FIG. 13 is a cross-sectional view taken through the line 13-13 in FIG. 1;

FIG. 14 is a detail view of a damper control lever of the outdoor cooking apparatus;

FIG. 15 is a perspective view showing the cooking apparatus installed within an outdoor kitchen;

FIG. 16 is a perspective view of an outdoor cooking apparatus having a preferred ornamental design;

FIG. 17 is a front elevational view of the outdoor cooking apparatus shown in FIG. 16;

FIG. 18 is a left side elevational view of the outdoor cooking apparatus shown in FIG. 16;

FIG. 19 is a top plan view of the outdoor cooking apparatus shown in FIG. 16;

FIG. 20 is a right side elevational view of the outdoor cooking apparatus shown in FIG. 16;

FIG. 21 is a rear elevational view of the outdoor cooking apparatus shown in FIG. 16; and

FIG. 22 is a bottom plan view of the outdoor cooking apparatus shown in FIG. 16.

### DETAILED DESCRIPTION OF PREFERRED EMBODIMENT

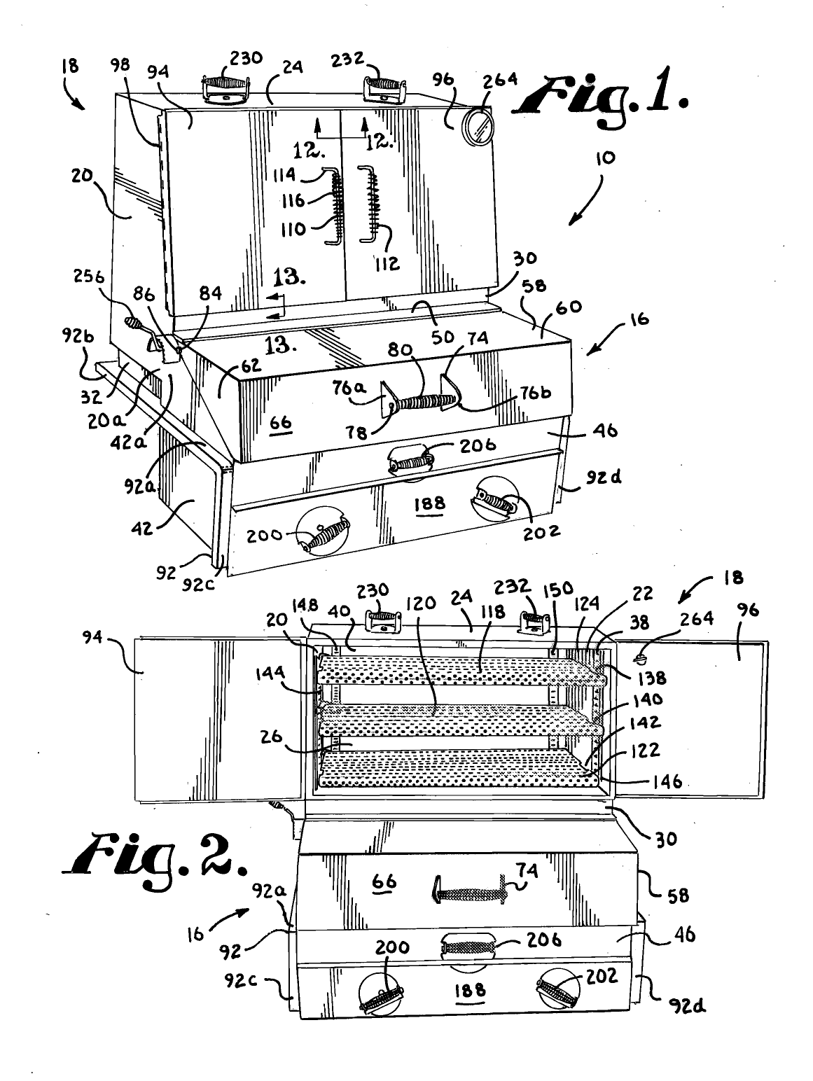

Referring to FIG. 1, an exemplary embodiment of outdoor cooking apparatus in accordance with the present invention is shown and designated by the reference numeral 10. The outdoor cooking apparatus 10 is designed for installation into an outdoor structure, such as the outdoor kitchen 12 shown in FIG. 15, which has a horizontal countertop surface 14 for supporting the outdoor cooking apparatus 10. The outdoor cooking apparatus 10 has both a direct cooking chamber 16, which may be used for high heat grilling and searing, and an indirect cooking chamber 18, which may be used as a smoker and/or convection oven for lower heat slow cooking. The direct and indirect cooking chambers 16 and 18 may be used at the same time, and, as described in more detail below, are heated with the same fuel source positioned in a lower portion of the direct cooking chamber 16. The indirect cooking chamber 18 is joined to and extends upward and rearward from the direct cooking chamber 16. The orientation of the indirect cooking chamber 18 with respect to the direct cooking chamber 16 allows an adult of average height to access both of the direct and indirect cooking chambers 16 and 18 when the cooking apparatus 10 is installed within an outdoor structure and supported by a countertop having a conventional height, which is typically approximately 36 inches. Further, the indirect cooking chamber 18 extends vertically upward from the rear of the direct cooking chamber 16 to increase the available volume for cooking within the indirect cooking chamber 18 while permitting the cooking apparatus 10 to have a relatively small footprint, or width and depth, such that the cooking apparatus 10 does not take up a large amount of counter space in an outdoor structure and can be dropped in to a conventional grill space.

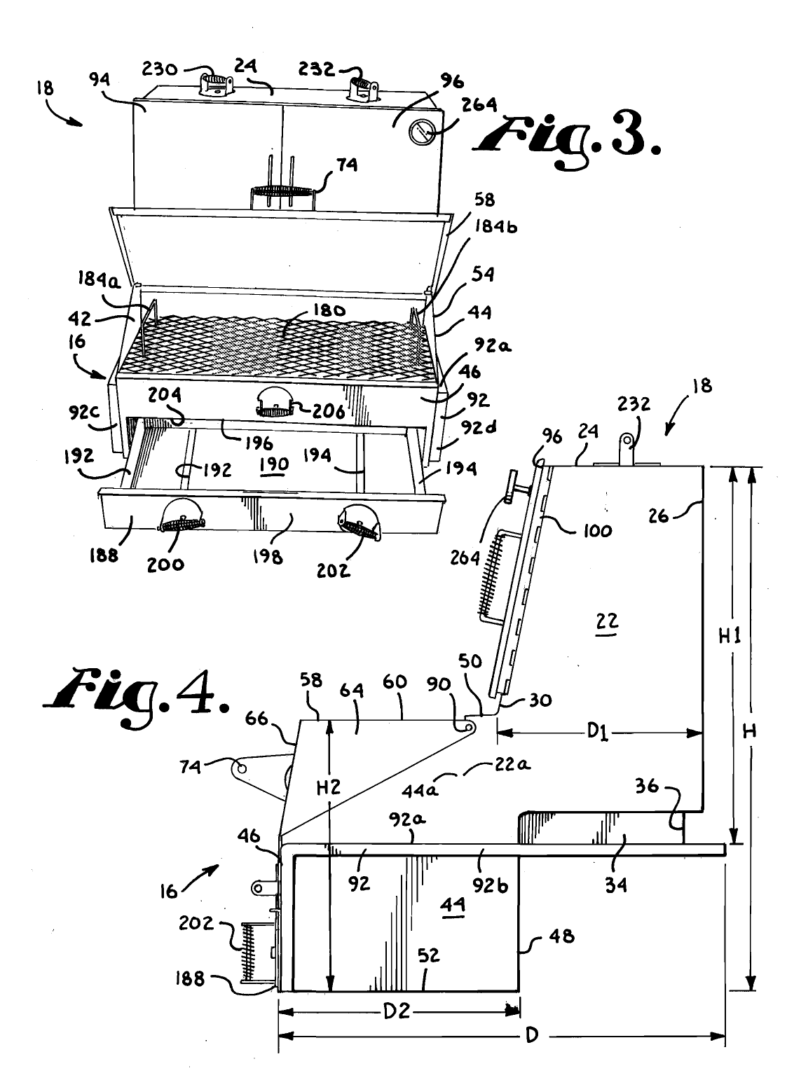

Referring to FIGS. 1, 4 and 5, the indirect cooking chamber 18 has first and second side walls 20 and 22 each joined with a top wall 24, a rear wall 26, a bottom wall 28, and a front wall 30. The rear wall 26 is also joined to the top wall 24 and bottom wall 28. Lower sections of the side walls 20 and 22 and rear wall 26 have an offset configuration such that lower sections 32 and 34 of the side walls 20 and 22, respectively, and a lower section 36 of the rear wall 26 are horizontally offset from the remainder of the respective side walls 20 and 22 and rear wall 26. The joined side walls 20 and 22, top wall 24, and front wall 30 present an opening 38, shown in FIG. 2, that is opposite rear wall 26. The joined walls 20, 22, 24, 26, 28, and 30 enclose an interior space 40, shown in FIG. 5.

Referring to FIGS. 1, 4, and 5, the direct cooking chamber 16 has first and second side walls 42 and 44 each joined with a front wall 46, a rear wall 48, a top wall 50 and a bottom wall 52. The bottom wall 52 is also joined to the rear wall 48 and front wall 46. Rearward edges 42a and 44a of the first and second side walls 42 and 44, respectively, of the direct cooking chamber 16 are joined with forward edges 20a and 22a of the first and second side walls 20 and 22, respectively, of the indirect cooking chamber 18, as shown in FIGS. 1 and 4. Preferably, the first and second side walls 42 and 44 of the direct cooking chamber 16 are integral with the first and second side walls 20 and 22 of the indirect cooking chamber 18 such that the line of demarcation between the walls is not clearly visible on the exterior of the cooking apparatus 10.

Referring to FIG. 5, the bottom wall 28 of the indirect cooking chamber 18 is joined with and extends rearward from near the top of the rear wall 48 of the direct cooking chamber 16. The front wall 30 of the indirect cooking chamber 18 is joined with and extends upward from the top wall 50 of the direct cooking chamber 16. The bottom wall 28 of the indirect cooking chamber 18 is vertically spaced above the bottom wall 52 of the direct cooking chamber 16 such that a substantial portion of the indirect cooking chamber 18 extends upward from the direct cooking chamber 16. The rear wall 26 of the indirect cooking chamber 18 is horizontally spaced rearward from the rear wall 48 of the direct cooking chamber 16 such that a majority of the indirect cooking chamber 18 is positioned rearward of the direct cooking chamber 16.

The joined walls 20, 22, 24, 26, 28, 30, 42, 44, 46, 48, 50, and 52 of the direct and indirect cooking chambers 16 and 18 are preferably joined by welding; however, it is within the scope of the invention for the walls to be joined in any manner. Further, it is within the scope of the invention for one or more of the walls 20, 22, 24, 26, 28, 30, 42, 44, 46, 48, 50, and 52 to be integral, and for any integral walls to be formed by bending a single sheet of material. Preferably, the front wall 30 of indirect cooking chamber 30 and the top wall 50 of direct cooking chamber 16 are integral with a bend between the two walls.

The joined side walls 42 and 44, front wall 46 and top wall 50 of the direct cooking chamber 16 present an opening 54, shown in FIG. 3, that is opposite the bottom wall 52. The joined walls 42, 44, 46, 48, 50, and 52 of the direct cooking chamber 16 enclose an interior space 56 shown in FIG. 5. A lid 58 is rotatably joined to the first and second side walls 42 and 44 of the direct cooking chamber 16 for accessing interior space 56. The lid 58 is moveable between the closed position shown in FIG. 1, in which it covers opening 54, and the open position shown in FIG. 3, in which it permits a user to access interior space 56. As shown in FIGS. 1, 4, and 5, the lid 58 has a top wall 60 joined with side walls 62 and 64 and a front wall 66. Referring to FIG. 5, the front wall 66 has a lower edge section 68 that is bent upward from the remainder of the front wall 66. The lower edge section 68 rests on a horizontal upper section 70 of front wall 46 when the lid 58 is in its closed position. The top wall 60 of lid 58 has a rear edge section 72 that is bent downward from the remainder of the top wall 60. Referring to FIG. 1, a handle 74 is joined to the front wall 66 of the lid 58. The handle 74 consists of two triangular shaped brackets 76a and 76b that are joined to the front wall 66, a rod 78 that extends between brackets 76a and 76b, and a spiral wound wire 80 that encircles rod 78.

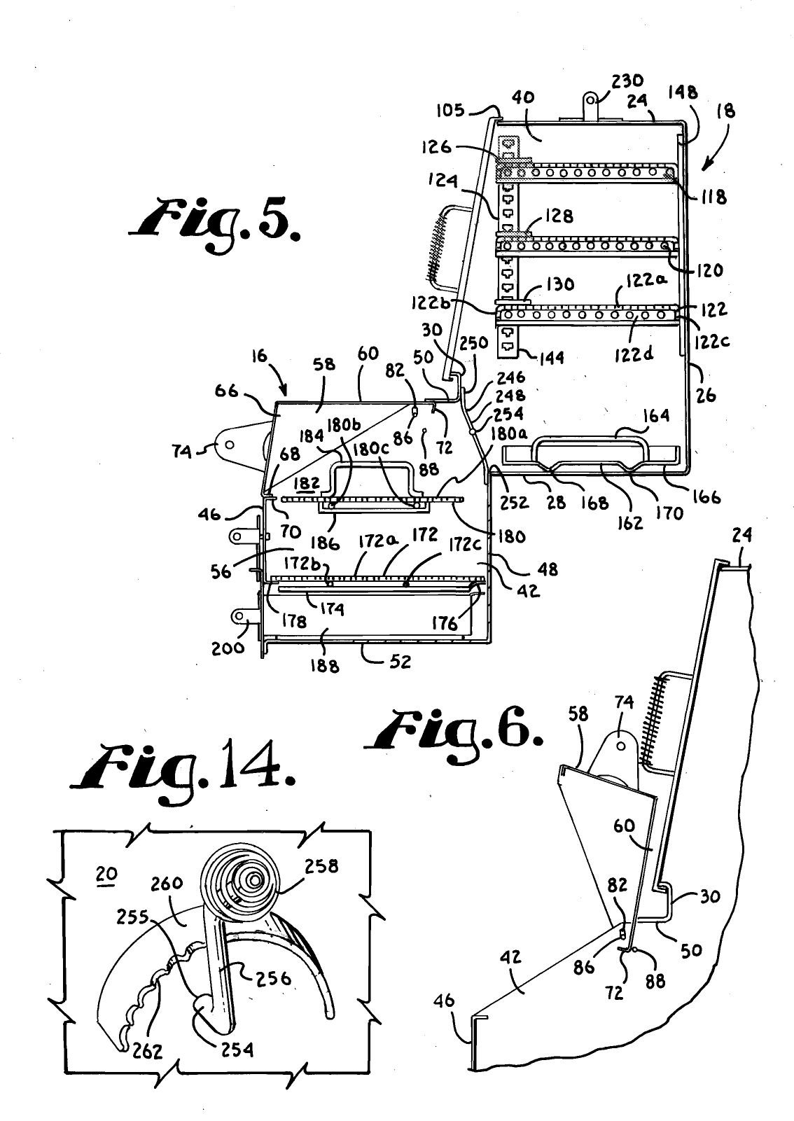

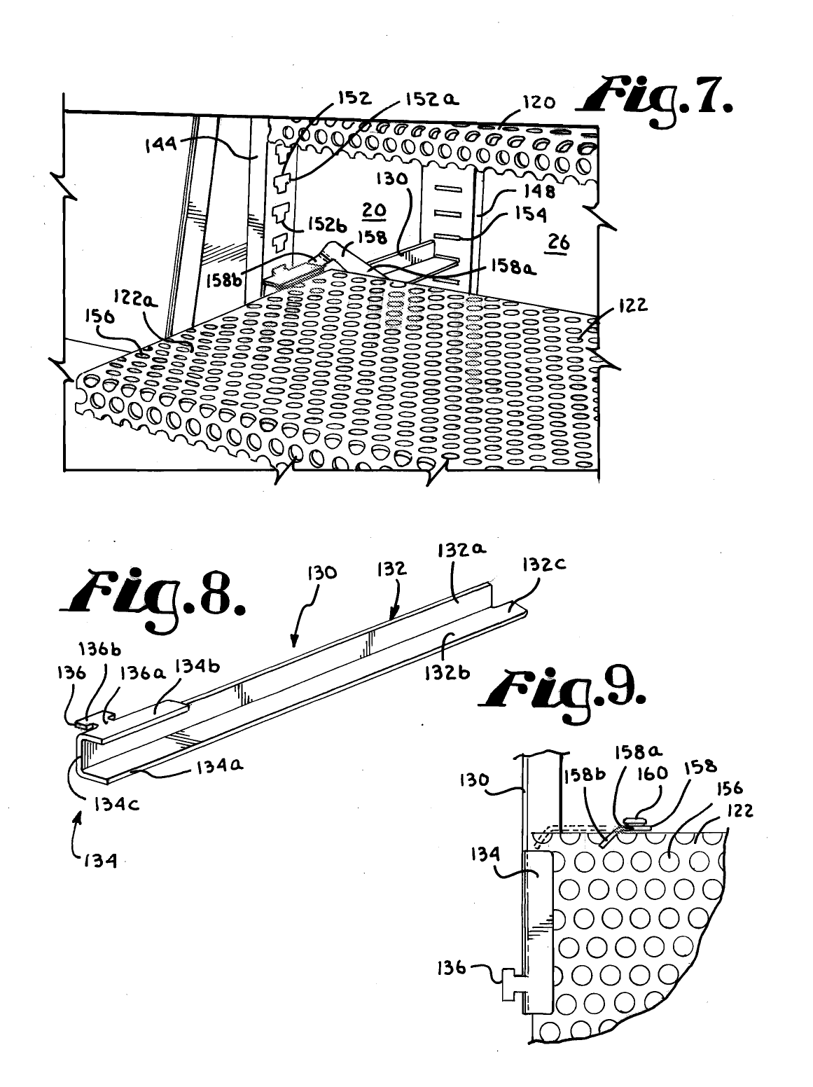

Referring to FIGS. 5 and 6, a slot 82 is formed in the side wall 42 of the direct cooking chamber 16. A corresponding hole 84, shown in FIG. 1, is formed in the side wall 62 of lid 58 and is aligned with slot 82. Threads (not shown) surround hole 84 for engaging the threads of a fastener 86 that is received by hole 84 and slot 82 for rotatably joining lid 58 to side wall 42 of the direct cooking chamber 16. A protrusion 88 is joined to side wall 42 of the direct cooking chamber 16. When lid 58 is in its open position, as shown in FIG. 6, fastener 86 is moveable within slot 82 between a locked position, in which the top wall 60 of lid 58 engages the protrusion 88 to prevent the lid 58 from moving to its closed position, and an unlocked position, in which the top wall 60 of lid 58 does not engage protrusion 88 and lid 58 is free to move to its closed position. In the locked position, fastener 86 is positioned in a lowermost portion of slot 82, as shown in FIG. 6, and in the unlocked position, fastener 86 is positioned in an uppermost portion of slot 82. Fastener 86 is moved between its locked and unlocked positions by grasping handle 74 and lifting lid 58 vertically upward when the lid is in the open position shown in FIG. 6. Thus, when lid 58 is moved from its closed position, shown in FIG. 5, to its open position, shown in FIG. 6, fastener 86 moves to its locked position in the lowermost portion of slot 82 due to the weight of lid 58 in order to prevent lid 58 from inadvertently closing. When it is desired to move lid 58 back to its closed position, handle 74 is grasped and lid 58 is lifted vertically upward to move fastener to its unlocked position in which the top wall 60 of lid 58 does not engage protrusion 88 and the lid 58 is free to rotate back to its closed position. Side wall 44 of direct cooking chamber 16 has a similar slot and protrusion (not shown) as side wall 42, and side wall 64 of lid 58 has a similar threaded hole (not shown) as side wall 62 which receives a fastener 90 (shown in FIG. 4) that rotatably joins the lid 58 to side wall 44 and is moveable between locked and unlocked positions in a similar manner as described above with respect to fastener 86.

Referring to FIG. 15, a flange 92 is joined to the direct and indirect cooking chambers 16 and 18 and is operable to rest on a horizontal surface of the structure within which the cooking apparatus 10 is installed, such as countertop 14, for supporting the cooking chambers 16 and 18. The flange 92 includes a continuous horizontal section 92a that is joined to and extends outward from the side walls 20 and 22 and rear wall 26 of the indirect cooking chamber 18, and the side walls 42 and 44 of the direct cooking chamber 16. A vertical section 92b is joined to and extends downward from the horizontal section 92a. Preferably, the vertical section 92b is integral with the horizontal section 92a and is continuous around the entire horizontal section 92a. The lower edge of the vertical section 92b rests on the horizontal countertop surface 14 and increases the rigidity of the flange 92 so that the flange 92 does not deform when supporting the weight of the entire cooking apparatus 10. The flange 92 also includes left and right front portions 92c and 92d that are joined with and extend outward from the front wall 46 of the direct cooking chamber 16. The left and right front portions 92c and 92d are designed to hide edges of the outdoor structure 12 within which the cooking apparatus 10 is installed, which are typically cut to accommodate the cooking apparatus 10. The flange 92 is positioned around the direct and indirect cooking chambers 16 and 18 such that substantially all of the indirect cooking chamber 18 is positioned above the flange 92, and approximately equal portions of the direct cooking chamber 16 are positioned above and below the flange 92, as shown best in FIG. 4. The positioning of the flange 92 allows a user to comfortably access both the direct and indirect cooking chambers 16 and 18 when the flange 92 is supported by a countertop having a conventional height, which is typically approximately 36 inches. The flange 92 is preferably welded to the direct and indirect cooking chambers 16 and 18; however, it may be joined to them in any manner or be integral with one or more walls of the cooking chambers 16 and 18.

Referring now to FIGS. 1 and 4, the indirect cooking chamber 18 has first and second doors 94 and 96 that are rotatably joined to side walls 20 and 22, respectively, preferably with piano hinges 98 and 100. The doors 94 and 96 are joined to the side walls 20 and 22 such that the doors 94 and 96 are rotatable about an approximately vertical axis between a closed position, as shown in FIG. 1, that covers opening 38 (FIG. 2) and an open position, as shown in FIG. 2, that permits a user to access the interior space 40 of the indirect cooking chamber 18. Because the doors 94 and 96 rotate about an approximately vertical axis, a user can easily open and close them without extending his or her arm vertically upward as would be necessary if the doors rotated about a horizontal axis. This permits an adult user of average height to operate the doors 94 and 96 when the flange 92 is supported by a countertop having a conventional height of approximately 36 inches. Referring to FIG. 13, the lower edge of door 94 includes a flange 102 that is bent upward from the front face of the door 94. The flange 102 engages a horizontal flange section 104 of the front wall 30 of the indirect cooking chamber 18 for substantially preventing hot air and smoke from escaping between the door 94 and front wall 30 when the door 94 is closed. Door 94 also includes an upper flange 105 (FIG. 5) that is bent downward from the front face of the door 94 for engaging top wall 24 of the indirect cooking chamber 18 and preventing the escape of hot air and smoke from the cooking chamber 18. Likewise, door 96 includes similar upper and lower flanges for engaging the walls of the indirect cooking chamber 18 and preventing the escape of hot air and smoke from the cooking chamber 18. Referring to FIG. 12, an edge 106 of door 94 overlaps an edge 108 of door 96 when the doors are in the closed position for substantially preventing the escape of hot air and smoke from the cooking chamber 18. The overlapped edge 108 of door 96 is bent rearward from the remainder of door 96 so that it is positioned underneath the edge 106 of door 94 and the exterior front faces of the doors 94 and 96 are flush when closed. As shown in FIG. 1, each door has a handle 110 and 112 for opening and closing the doors. Handle 110 consists of a C-shaped rod 114 joined to the door near edge 106 and a spiral wound wire 116 that encircles a portion of rod 114. Handle 112 has a similar construction and as such is not described in detail herein.

Referring to FIGS. 2 and 5, the indirect cooking chamber 18 includes three adjustable, vertically spaced shelves 118, 120, and 122 that are positioned within an indirect cooking area 124 of the interior space 40 that is positioned above flange 92. Each of the shelves 118, 120, and 122 is supported by a pair of brackets, one bracket of each pair being shown as 126, 128, and 130 in FIG. 5, that are adjustably supported by the side walls 20 and 22 and rear wall 26 of the indirect cooking chamber 18. Brackets 126, 128, and 130 are substantially similar; accordingly, only bracket 130, shown in FIG. 8, is described in detail herein. Bracket 130 includes an L-shaped portion 132 having joined vertical and horizontal sections 132a and 132b, and a C-shaped portion 134 that is integrally joined with the L-shaped portion 132. The C-shaped portion 134 has first and second spaced apart horizontal sections 134a and 134b joined by a vertical section 134c. The vertical section 134c and first horizontal section 134a of the C-shaped portion 134 are integral with the vertical and horizontal sections 132a and 132b of the L-shaped portion 132. The horizontal section 132b has a rear end 132c that extends rearward from the end of the vertical section 132a. A tab, or protrusion, 136 is integrally joined with the horizontal section 134b. The tab 136 includes a narrow rectangular section 136a extending outwardly from the horizontal section 134b, and a wider rectangular section 136b joined with section 136a. The other bracket in each of the pair of brackets supporting shelves 118, 120, and 122 (shown in FIG. 2 as 138, 140, and 142) is a mirror image of brackets 126, 128 and 130. Accordingly, brackets 138, 140, and 142 are not described in detail herein.

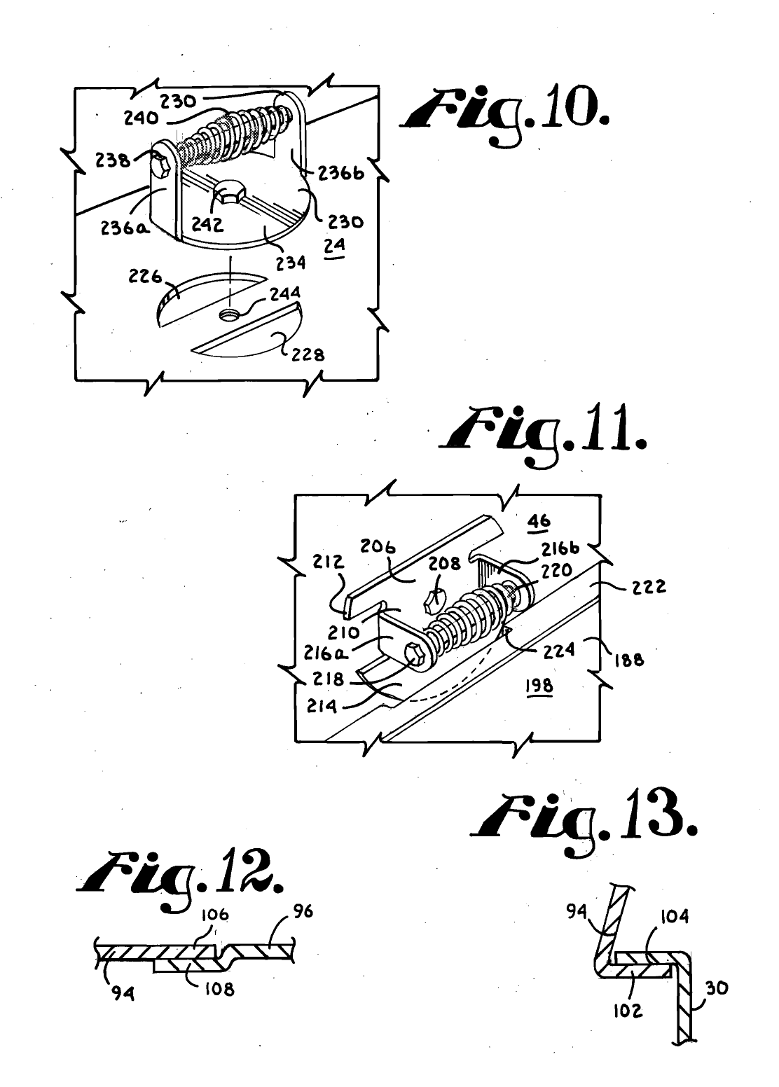

Referring to FIGS. 2 and 8, slotted bars 144 and 146 are mounted on side walls 20 and 22 for receiving the tabs 136 (FIG. 8) of brackets 126, 128, 130, 138, 140, and 142, and slotted bars 148 and 150 are mounted on rear wall 26 for receiving the rear end 132c (FIG. 8) of brackets 126, 128, 130, 138, 140, and 142. Slotted bars 144 and 146 are substantially similar; accordingly, only bar 144, as partially shown in FIG. 7, is described in detail herein. Bar 144 includes a plurality of vertically spaced slots, one of which is identified as 152, for receiving the tabs 136 of brackets 126, 128, and 130. Slot 152 includes a relatively wide rectangular section 152a with a width that is slightly larger than the width of the rectangular section 136b of the tab 136 on bracket 130 (FIG. 8) so that the section 152a of slot 152 can receive the section 136b of tab 136. The slot 152 also includes a narrower rectangular section 152b with a width that is slightly larger than the width of the rectangular section 136a of the tab 136 on bracket 130 (FIG. 8) so that the section 152b of slot 152 can receive the section 136a of tab 136. The width of section 152b is smaller than the width of section 136b of tab 136. In use, the rectangular section 136b of tab 136 is inserted into the section 152a of slot 152 and bracket 130 is moved downward so that section 136a of tab 136 is received by section 152b of slot 152. In this position, the section 136b of tab 136 abuts an interior surface of bar 144 preventing bracket 130 from moving laterally with respect to bar 144. To remove tab 136 from slot 152, the bracket 130 is lifted upward until section 136b of tab 136 aligns with section 152a of slot 152, and outward until the tab 136 is no longer received by slot 152. Slotted bars 148 and 150 are substantially similar; accordingly, only bar 148, as shown in FIG. 7, is described in detail herein. Bar 148 includes a plurality of vertically spaced rectangular slots, one of which is identified as 154, each corresponding with one of slots 152 on bar 144. The slots 154 are operable to receive the rear ends 132c of brackets 126, 128, and 130 for supporting the brackets 126, 128, and 130 and corresponding shelves 118, 120, and 122.

Thus, each of brackets 126, 128, and 130 is vertically adjustable between a plurality of positions within the indirect cooking area 124 by inserting the tabs 136 and rear ends 132c of the respective brackets 126, 128, and 130 in the desired slots 152 and 154 on bars 144 and 148, respectively. Likewise, each of brackets 138, 140, and 142 (FIG. 2) is vertically adjustable between a plurality of positions by inserting the tabs 136 and rear ends 132c of the respective brackets 138, 140, and 142 in the desired slots (not shown) on bars 146 and 150. Each pair of brackets 126 and 138, 128, and 140, and 130 and 142 are preferably vertically adjusted to a position where the brackets within a pair are horizontally aligned such that each pair of brackets is operable to support one of shelves 118, 120, and 122 in a horizontal position.

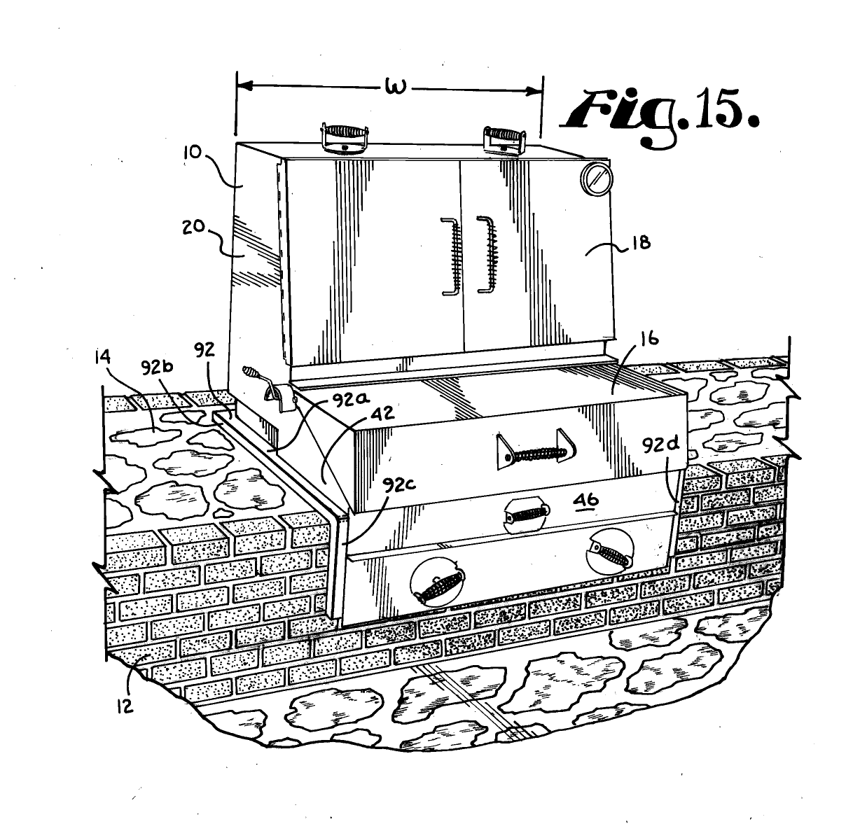

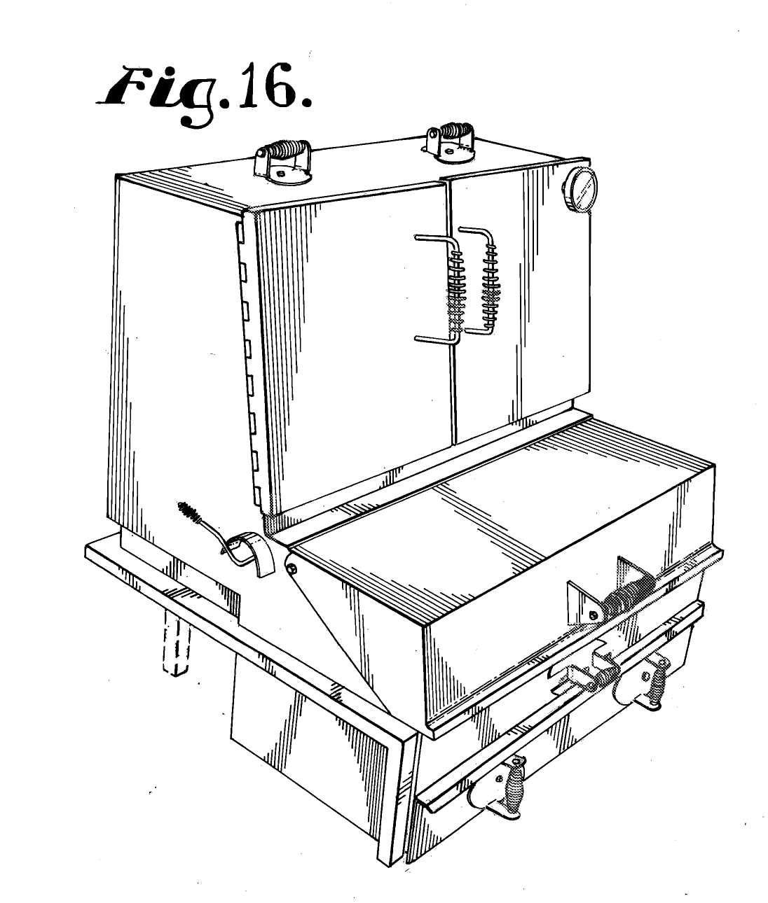

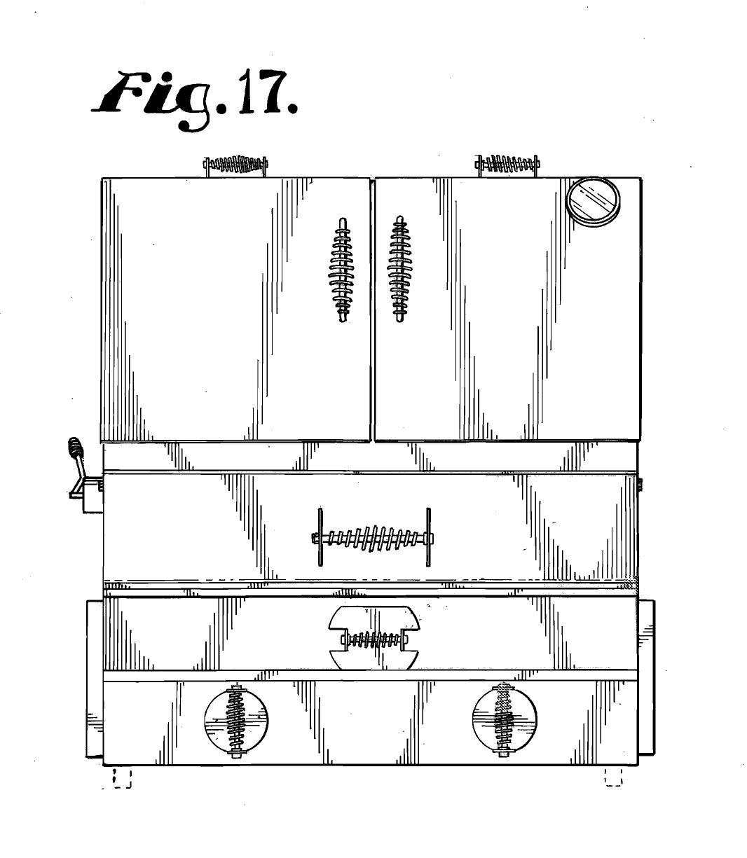

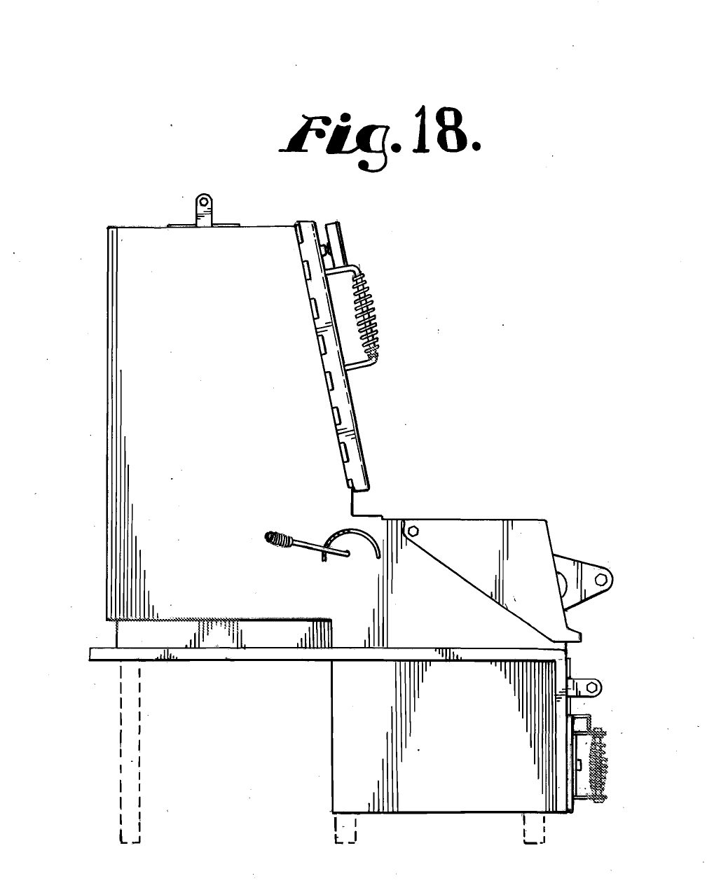

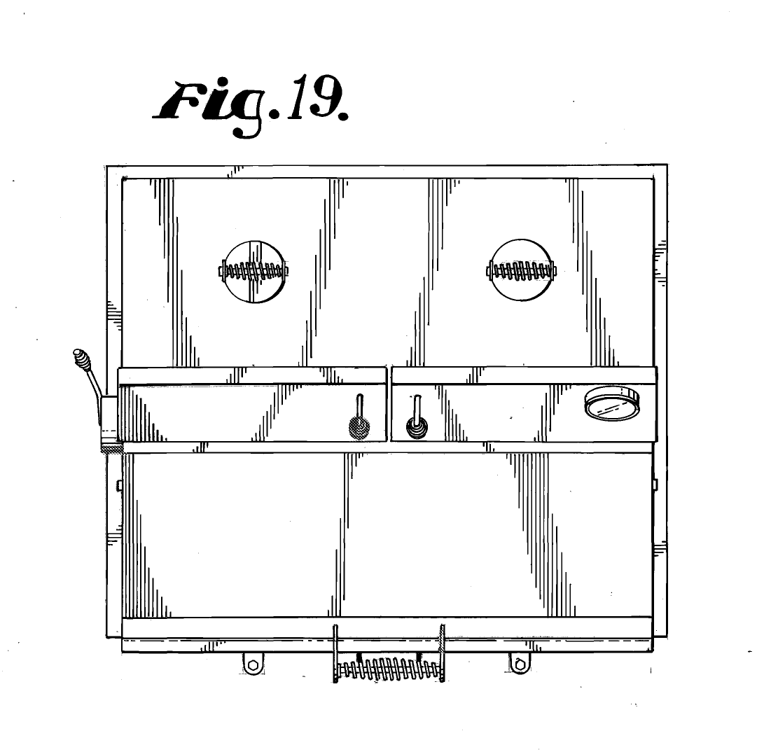

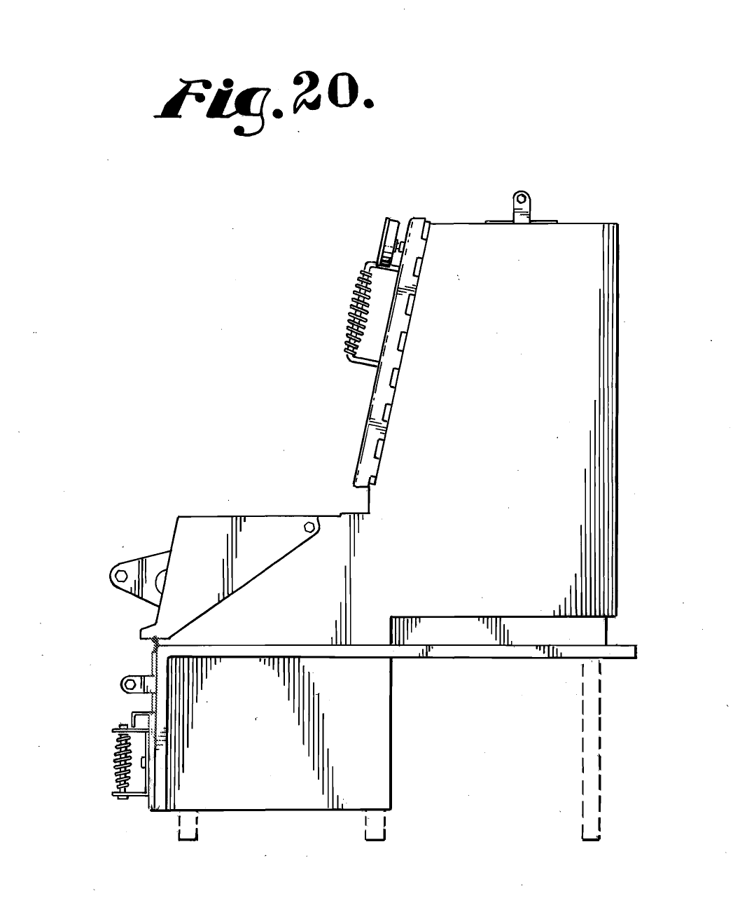

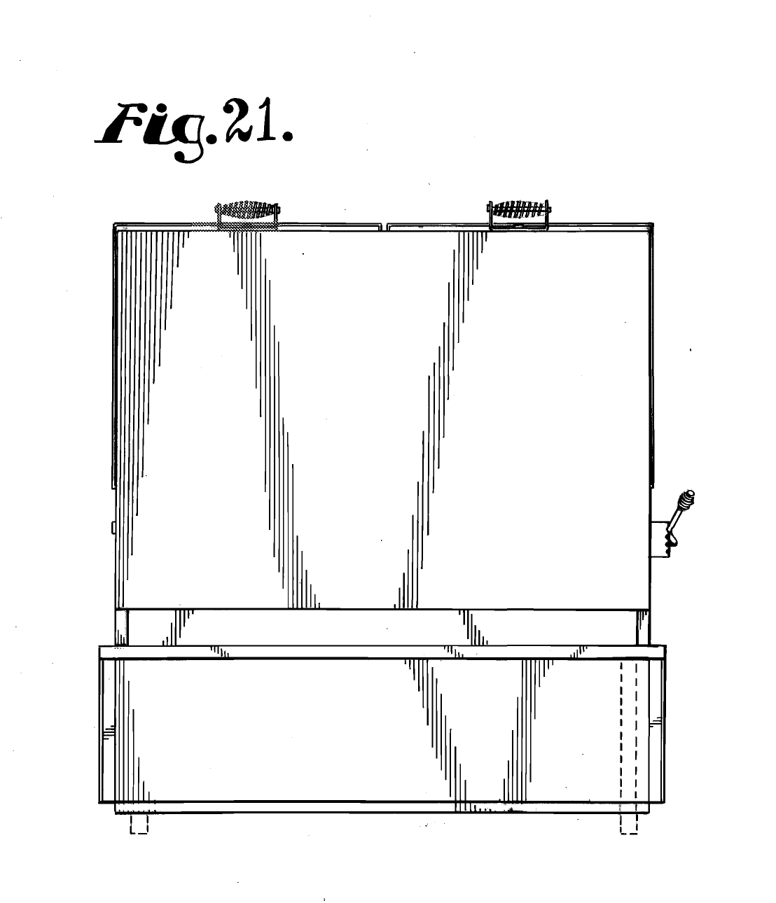

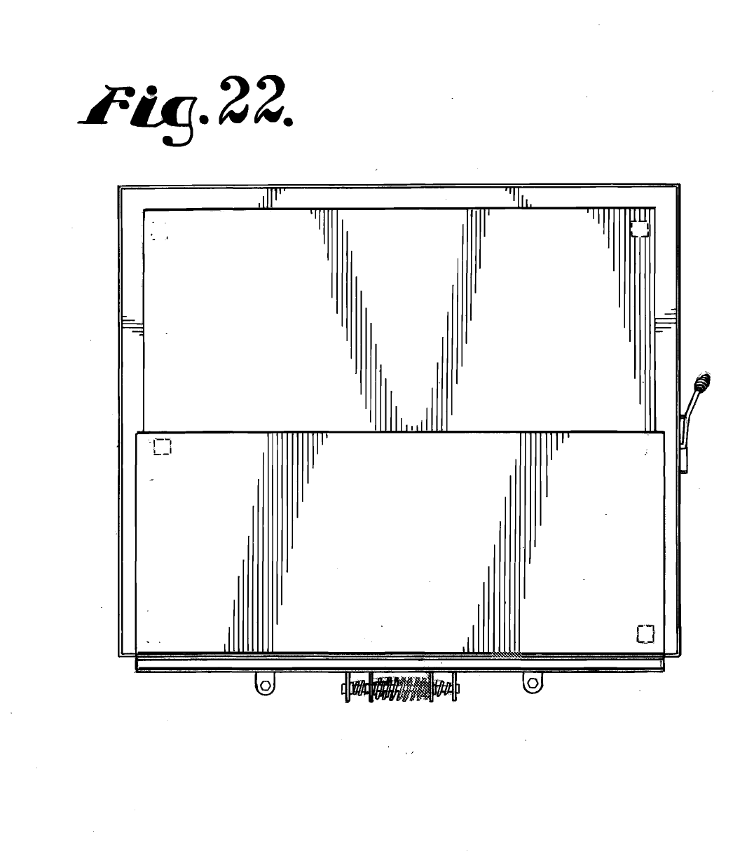

Each of the shelves 118, 120, and 122 is substantially similar; accordingly, only shelf 122 is described in detail herein with reference to FIGS. 5, 7, and 9. Shelf 122 has a generally horizontal surface 122a, and front, rear, and side edges 122b-d (the side edge opposite side edge 122d is not shown) that are integral with horizontal surface 122a and bent downward from the horizontal surface 122a to increase the rigidity of shelf 122. Each of the surfaces 122a-d includes a plurality of holes, one of which is shown as 156, for allowing smoke and hot air to rise through the shelf 122 and grease and moisture to drip through the shelf 122. The side edge 122d of shelf 122 is supported by the horizontal sections 132b and 134a (FIG. 8) of bracket 130, and the other side edge (not shown) of shelf 122 is supported by bracket 142 (FIG. 2). The horizontal sections 134a and 134b of bracket 130 are spaced apart slightly more than the height of shelf 122 so that shelf 122 may slide over section 134a between the sections 134a and 134b. Section 134b prevents shelf 122 from moving upward when it is supported by bracket 130. Shelf 122 may slide over brackets 122 and 142 away from rear wall 26 and through opening 38 (FIG. 2) so that a user can easily access the shelf for placing items on the shelf 122 or removing items from the shelf 122. When shelf 122 is in this position, a lock 158 (FIGS. 7 and 9), which is moveable between the unlocked position shown in solid lines in FIG. 9 and the locked position shown in dashed lines, is operable to prevent the shelf 122 from sliding off the brackets 130 and 146. When in the locked position, lock 158 engages the C-shaped portion 134 of bracket 130 for preventing shelf from sliding off of bracket 130. The lock 158 includes a first elongate section 158a that is joined to the rear edge 122c of shelf 122 with a rivet 160 (FIG. 9), and a second section 158b that extends outward and forward at an angle from section 158a. Section 158b engages the C-shaped portion 134 of bracket 130 when lock 158 is in its locked position as shown in FIGS. 7 and 9. Lock 158 is rotatable around rivet 160 to move between its locked and unlocked positions. Another lock (not shown), which is the mirror image of lock 158, is joined to the opposite side of the rear edge 122c of shelf 122 for engaging bracket 146 (FIG. 2) when in its locked position.

Shelves 118 and 120 are supported by and are operable to slide over pairs of brackets 126 and 138 and 128 and 140, respectively, in a similar manner as described above for shelf 122 and brackets 130 and 142. Shelves 118 and 120 also each include a pair of locks (not shown) for engaging the brackets 126 and 138 and 128 and 140 in a similar manner as described above with respect to shelf 122 and lock 158.

The brackets 126, 128, 130, 138, 140, and 142 and corresponding shelves 118, 120, and 122 are vertically adjustable for allowing a user to vary the vertical distance between two adjacent shelves depending on what is being cooked on a particular shelf. For example, if pork ribs are horizontally placed on shelf 122 for smoking, shelf 120 may be adjusted so that it is relatively close to shelf 122, which would leave more room above shelves 120 and 118 for smoking other types of food such as pork shoulder, beef brisket, or whole chickens or turkeys. It is within the scope of the invention for the cooking apparatus 10 to have more or less than three shelves. Further, it is within the scope of the invention for any shelves 118, 120, and 122 to be non-adjustable and to be supported by portions of the indirect cooking chamber 18 in any manner. For example, permanent ledges may be joined to side walls 20 and 22 for supporting the shelves 118, 120, and 122.

Referring to FIG. 5, a grease pan 162 is positioned beneath shelves 118, 120, and 122 for collecting grease and any other material falling downward through shelves 118, 120, and 122. The grease pan 162 has a pair of handles, one of which is shown as 164, and a bottom wall 166 with two grooves 168 and 170 that rest on the bottom wall 28 of indirect cooking chamber 18. The grooves 168 and 170 space the remainder of bottom wall 166 of grease pan 162 from the bottom wall 28 of the indirect cooking chamber 18 to prevent the grease pan 162 from sticking to the bottom wall 28 due to oxidation and/or hardened grease.

As shown in FIG. 5, the direct cooking chamber 16 includes a charcoal grate 172 for supporting charcoal, wood, and/or other fuel. The charcoal grate 172 includes a horizontal surface 172a with openings for allowing spent fuel to pass through the grate 172 and two support rods 172b and 172c welded to the bottom of surface 172a. The rods 172b and 172c are supported by, and preferably welded to, a ledge 174 joined with side wall 42 and another ledge (not shown) joined with side wall 44. The grate 172 is also supported by, and preferably welded to, a ledge 176 joined with rear wall 48, and an integral ledge 178 of front wall 46.

A grilling grate 180 is removably positioned in a direct cooking area 182 of the direct cooking chamber 16 above charcoal grate 172. The grilling grate 180 includes a horizontal surface 180a with openings for allowing hot air and smoke to rise through the grate 180 and grease and moisture to drip through the grate 180. Support rods 180b and 180c are welded to the bottom of surface 180a, and handles 184a and 184b (FIG. 3) are welded to the top of surface 180a. The rods 180b and 180c are supported by a U-shaped ledge 186 joined to side wall 42. The vertical sections of ledge 186 constrain the grate 180 so that the grate 180 is not positioned too far rearward within the direct cooking area 182 where it could interfere with a damper system 246 described below. The grate 180 is removable in the event that a user only desires to cook solely within the indirect cooking chamber 18.

Referring to FIGS. 3 and 5, a removable ash pan 188 is positioned below the charcoal grate 172 for receiving ashes from spent fuel on grate 172. As shown in FIG. 3, the ash pan 188 includes a bottom wall 190 that is joined to left side, right side, rear, and front walls 192, 194, 196, and 198, respectively. The bottom wall 190 includes two ridges 192 and 194 that rest on and slide over the bottom wall 52 (FIG. 5) of direct cooking chamber 16. The ridges 192 and 194 space the remainder of the bottom wall 190 of ash pan 188 from the bottom wall 52 of the indirect cooking chamber 18 to prevent the ash pan 188 from sticking to the bottom wall 52 due to oxidation or hardened grease. Handles (which, as described below, also function as valves) 200 and 202 are joined to the front wall 198 so that a user may grasp them and slide the ash pan 188 through an opening 204 in the front wall 46 of direct cooking chamber 16 for emptying the ash pan 188.

Referring to FIG. 11, an ash pan lock 206 is rotatably joined to the front wall 46 of the direct cooking chamber 16 with a fastener 208. The ash pan lock 206 includes a central section 210 that is integral with two opposing end sections 212 and 214. The central section 210 includes two handle tabs 216a and 216b that are bent outward at 90 degrees with respect to the remainder of the central section 210. The tabs 216a and 216b are preferably integral with the remainder of the central section 210, and are preferably formed by cutting slots into the central section on either side of each of the tabs 216a and 216b and bending the tabs 216a and 216b approximately 90 degrees with respect to the remainder of the central section 210. The tabs 216a and 216b have holes for receiving a rod such as fastener 218. A spiral wound wire 220 encircles a portion of fastener 218 so that a user may grasp the wire 220 for rotating lock 206. End section 212 is generally rectangular, and end section 214 is semi-circular. Preferably, the lock 206 is formed from a single, circular sheet of material that is cut to form end section 212 by removing approximately one third of the circle.

The front wall 198 of the ash pan 188 includes an integral horizontal ledge 222 that is bent 90 degrees with respect to the remainder of the vertical front wall 198. A slot 224 is formed in the ledge 222 adjacent to ash pan lock 206. The slot 224 receives the semi-circular end 214 of ash pan lock 206 when the lock 206 is in a locked position, shown in FIG. 11, to prevent movement of the ash pan 188 with respect to the front wall 46 of the direct cooking chamber 16. The lock 206 rotates 180 degrees from the position shown in FIG. 11 to an unlocked position in which the ash pan 188 is free to move with respect to front wall 46. In the unlocked position, the rectangular end section 212 of lock 206 is spaced above slot 224 such that it is not received by slot 224.

Referring to FIG. 1, the direct cooking chamber 16 includes two intake vents (not shown) behind each of the ash pan handles/intake valves 200 and 202 for regulating air flow to burning fuel within the direct cooking chamber 16. The indirect cooking chamber 18 includes two exhaust vents (two of which are shown in FIG. 10 as 226 and 228) behind each of exhaust valves 230 and 232 for allowing smoke and hot air to exit the indirect cooking chamber 18 which also helps control the temperature within the indirect cooking chamber 18. Each of the intake vents and exhaust vents are substantially similar, and each of the intake valves 200 and 202 and exhaust valves 230 and 232 are substantially similar. Accordingly, only exhaust vents 226 and 228 and exhaust valve 230 are described in detail herein with reference to FIG. 10.

The exhaust vents 226 and 228 are each semi-circular openings in the top wall 24 of indirect cooking chamber 18. The exhaust valve 230 includes a circular base 234 that covers vents 226 and 228 when in a closed position and two handle tabs 236a and 236b extending outward at a 90 degree angle from the base 234. The tabs 236a and 236b have holes for receiving a rod such as fastener 238. A spiral wound wire 240 encircles a portion of fastener 238 so that a user may grasp the wire 240 for rotating exhaust valve 230. A threaded fastener 242 is joined to the center of circular base 234. The threads on fastener 242 are received by and engage a threaded opening 244 that is positioned between vents 226 and 228 in top wall 24. The exhaust valve 230 is rotatable between a closed position, in which the valve 230 is rotated such that the circular base 234 abuts top wall 24 and covers vents 226 and 228, and a plurality of adjustable open positions, in which base 234 is spaced from top wall 24 and smoke and hot air can exit the indirect cooking chamber 18 through vents 226 and 228. As exhaust valve 230 is rotated counter-clockwise from its closed position, the circular base 234 moves farther away from vents 226 and 228 and top wall 24 through a plurality of adjustable open positions. As the valve 230 moves farther away from the vents 226 and 228, more air can flow out of the indirect cooking chamber 18 through the vents 226 and 228. Thus, a user can vary the rate of air flow through the vents 226 and 228 to a desired amount by rotating the exhaust valve 230 to a position where the base 234 is spaced a desired distance from the top wall 24 of indirect cooking chamber 18. The positions of the exhaust valves 230 and 232 are preferably adjusted to affect the temperature and flavor of the food within the indirect cooking chamber 18.

Exhaust valve 232 and intake valves 200 and 202 operate in the same way as exhaust valve 230 such that a user can rotate them with respect to the top wall 24 of indirect cooking chamber 18 and the front wall 198 of ash pan 188, respectively, for varying the rate of air flow through exhaust vents (not shown) in the top wall 24 of indirect cooking chamber 18 and intake vents (not shown) in the front wall 198 of ash pan 188, respectively, that are similar to vents 226 and 228 (FIG. 10). Rotation of the intake valves 200 and 202 allows a user to control the rate of air flow to the burning fuel within the direct cooking chamber 16. By closing the intake valves 200 and 202, fuel burning within the direct cooking chamber 16 may be extinguished, and by rotating the intake valves 200 and 202 between a plurality of open positions, the rate at which the fuel burns within the direct cooking chamber 16 and the temperature within the direct and indirect cooking chambers 16 and 18 may be controlled. As the intake valves 200 and 202 are rotated counter-clockwise the gap between the valves 200 and 202 and front wall 198 enlarges causing a greater air flow rate into direct cooking chamber 16 which increases the rate at which fuel burns within the chamber 16 and increases the temperature of the direct cooking chamber 16.

Referring to FIG. 5, the cooking apparatus 10 has a damper 246 to regulate the temperature within indirect cooking chamber 18 by regulating the flow of hot air and smoke from direct cooking chamber 16 to indirect cooking chamber 18. The damper 246 is a sheet of material that extends the width of the cooking apparatus 10 between the side walls 20 and 22 of the indirect cooking chamber 18. As such, when the damper 246 is moved to one of its plurality of open positions described below, hot air flows from the direct cooking chamber 16 to the indirect cooking chamber 18 across the entire width of the cooking apparatus 10, which assists in maintaining a uniform temperature across the width of the indirect cooking chamber 18 for evenly cooking food positioned at different locations across the width of the indirect cooking chamber 18.

The damper 246 includes a generally planar middle section 248 and first and second end sections 250 and 252 integral with the middle section 248. The first and second end sections 250 and 252 are each bent at a slight angle with respect to the middle section 248 so that when the damper 246 is in the closed position shown in FIG. 5, first end section 250 is parallel to and abuts the front wall 30 of indirect cooking chamber 18 and second end section 252 is parallel to and abuts the rear wall 48 of the direct cooking chamber 16 for preventing fluid flow between the direct and indirect cooking chambers 16 and 18. Two rods (one of which is shown as 254 in FIGS. 5 and 14) are joined to the middle section 248 of the damper 246. Rod 254 is received by an opening 255 in the side wall 20 of the indirect cooking chamber 18, and the other rod (not shown) is received by an opening (not shown) in side wall 22 to rotatably join the damper 246 to the side walls 20 and 22. Alternatively, it is within the scope of the invention for a single rod to replace the two rods and span the entire width of the damper 246. The damper 246 is rotatable in a clockwise direction (when viewed as shown in FIG. 5) between the closed position shown in FIG. 5 and a plurality of adjustable open positions for controlling the rate at which air flows between the direct and indirect cooking chambers 16 and 18 and the temperature within indirect cooking chamber 18.

Referring to FIG. 14, the damper 246 has a control lever 256 that is integral with rod 254 and extends outward at an angle from rod 254 to provide leverage for rotating damper 246 between its closed position and a plurality of open positions. A spiral wound wire 258 encircles the end of lever 256 so that a user may easily grasp the wire 258 and move the lever 256. A semi-circular sheet 260 is joined to the side wall 20 of indirect cooking chamber 16. The sheet 260 includes a plurality of notches, one of which is shown as 262, each for receiving a portion of control lever 256 and maintaining damper 246 in one of its plurality of positions. Lever 256 is positioned such that when it is unstressed, it is received by one of notches 262. To move lever 256 between the notches 262, force is applied to the end of lever 256 to flex it with respect to rod 254 and move it out of the notch 262 which receives it. The lever 256 is then moved adjacent to the desired notch 262, and the operator lets go of the lever 256 so that it flexes back toward sheet 260 into the desired notch 262.

Each of the notches 262 corresponds with a different position of damper 246 such that as the control lever 256 is moved from right to left as shown in FIG. 14, the damper 246 gradually moves from its closed position through a plurality of open positions that progressively allow a greater air flow rate between the direct and indirect cooking chambers 16 and 18 for regulating the temperature of indirect cooking chamber 18 and the amount of smoke flowing therein. With the intake and exhaust valves 200, 202, 230, and 232 in a set position and the fuel within direct cooking chamber 16 burning at a relatively steady rate, movement of damper 246 to a position allowing a greater air flow rate into the indirect cooking chamber 18 increases the temperature within the indirect cooking chamber 18 and the amount of smoke flowing therein. Likewise, movement of damper 246 to a position that decreases the air flow rate into the indirect cooking chamber 18 decreases the temperature within the indirect cooking chamber 18 and the amount of smoke flowing therein. A thermometer 264, shown in FIG. 1, is mounted to door 96 for allowing a user to monitor the temperature within the indirect cooking chamber 18.

Referring to FIG. 4, the indirect cooking chamber 18 has a height H1 of preferably between approximately 15 to 30 inches and most preferably approximately 21 3/16 inches plus or minus 1/16 of an inch. The indirect cooking chamber has a depth D1 of preferably between approximately 10 to 20 inches and most preferably approximately 13 5/16 inches plus or minus 1/16 of an inch. Preferably, the ratio of H1 to D1 is between approximately 1 to 3 and most preferably is approximately 1.6. The direct cooking chamber 16 has a height H2 of preferably between approximately 10 to 20 inches and most preferably approximately 14⅜ inches plus or minus 1/16 of an inch. The direct cooking chamber 16 has a depth D2 of preferably between approximately 10 to 20 inches and most preferably approximately 13 3/16 inches plus or minus 1/16 of an inch. Preferably, the ratio of H2 to D2 is between approximately 0.5 to 2 and most preferably is approximately 1.1. The entire cooking apparatus 10 has a height H of preferably between approximately 25 to 45 inches and most preferably approximately 32 3/16 inches plus or minus 1/16 of an inch. The entire cooking apparatus 10 has a depth D of preferably between approximately 20 to 35 inches and most preferably approximately 26⅛ inches plus or minus 1/16 of an inch. Preferably, the ratio of H to D is between approximately 0.75 to 2 and most preferably is approximately 1.2. Referring to FIG. 15, the cooking apparatus 10 has a width W that may vary depending on the size of the cutout in the outdoor kitchen 12 within which the cooking apparatus 10 is installed. Preferably, the width W of the cooking apparatus 10 is such that it may be installed within an outdoor kitchen 12 having a cutout designed to accept an appliance having a standard width, such as 30, 36, 42, 48, 56, or 60 inches. The dimensions and ratios set forth above are preferably chosen to allow an adult of average height to access the direct and indirect cooking chambers 16 and 18 when the cooking apparatus 10 is supported by a conventional height countertop, while maximizing the available cooking volume within the indirect cooking chamber 18 and minimizing, to the extent possible, the amount of countertop space that the cooking apparatus 10 occupies.

In operation, fuel such as charcoal and wood is placed on the charcoal grate 172 within the direct cooking chamber 16 and lit. The intake valves 200 and 202 and exhaust valves 230 and 232 are opened to a desired position and the lid 58 is closed. For cooking within the indirect cooking chamber 18, shelves 118, 120, and 122 are moved to the desired positions by adjusting brackets 126, 128, 130, 138, 140, and 142 in the manner described above. Further, the damper 246 is opened to a desired position. The temperature within the indirect cooking chamber 18 is monitored on thermometer 264 until it reaches a desired level. Intake valves 200 and 202, exhaust valves 230 and 232 and damper 246 may be adjusted to raise or lower the temperature within the indirect cooking chamber 18. When the temperature is at a desired level, food is placed on the shelves 118, 120, and 122 and doors 94 and 96 are shut. While food is cooking in the indirect cooking chamber 18, food may also be cooked in the direct cooking chamber 16 by placing it on grilling grate 180. The direct cooking chamber 16 may also be used without using the indirect cooking chamber 18. As the food cooks (e.g., meats, potatoes, corn on the cob, roasted vegetables, casseroles, pies, cakes, cobblers, etc.), additional fuel may be added as necessary and desired. When the food has finished cooking, it is removed from the shelves 118, 120, and 122 and the grease and ash pans 162 and 188 may be removed and emptied.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. An outdoor cooking apparatus operable for installation into an outdoor structure, comprising:
a direct cooking chamber;
an indirect cooking chamber joined to and extending at least partially upward and rearward from said direct cooking chamber, wherein said indirect cooking chamber comprises:
first and second side walls each joined with a top wall and a rear wall, wherein said joined walls present an opening opposite said rear wall,
first and second doors rotatably joined to said first and second side walls, respectively, wherein each of said doors is rotatable about an approximately vertical axis between a closed position that blocks a portion of said opening and an open position, and
a plurality of vertically spaced shelves supported by at least one of said walls;
a flange joined to at least one of said direct and indirect cooking chambers, wherein said flange is operable to engage a portion of the structure within which the cooking apparatus is installed for supporting said direct and indirect cooking chambers; and
a damper operable to regulate fluid flow between said direct and indirect cooking chambers.

2. The cooking apparatus of claim 1, wherein said opening comprises a first opening, wherein said indirect cooking chamber further comprises a bottom wall joined with said first and second side walls and said rear wall, and a front wall joined with said first and second side walls, wherein said direct cooking chamber comprises first and second side walls each joined with front, rear, top and bottom walls, wherein said joined walls of said direct cooking chamber present a second opening opposite said bottom wall of said direct cooking chamber, wherein rearward edges of said first and second side walls of said direct cooking chamber are joined with forward edges of said first and second side walls of said indirect cooking chamber, respectively, wherein said bottom wall of said indirect cooking chamber is joined with and extends rearward from said rear wall of said direct cooking chamber, wherein said front wall of said indirect cooking chamber is joined with and extends upward from said top wall of said direct cooking chamber, wherein said bottom wall of said indirect cooking chamber is vertically spaced above said bottom wall of said direct cooking chamber, and wherein said rear walls of said direct and indirect cooking chambers are horizontally spaced.

3. The cooking apparatus of claim 2, wherein said flange is joined to said first and second side walls of each of said direct and indirect cooking chambers.

4. The cooking apparatus of claim 2, wherein said damper comprises a middle section and first and second end sections joined to said middle section, wherein said middle section is rotatably joined to said first and second side walls of said indirect cooking chamber, wherein said damper is rotatable between a closed position blocking fluid flow between said direct and indirect cooking chambers and an open position allowing fluid flow between said direct and indirect cooking chambers, and wherein when said damper is in said closed position said first end section abuts said front wall of said indirect cooking chamber and said second end section abuts said rear wall of said direct cooking chamber.

5. The cooking apparatus of claim 4, wherein said damper further comprises a control lever joined to said middle section for rotating said damper between a plurality of positions, and wherein one of said side walls of said indirect cooking chamber comprises a plurality of notches each operable to receive a portion of said control lever and each corresponding with one of said positions of said damper.

6. The cooking apparatus of claim 2, wherein said direct cooking chamber further comprises a lid rotatably joined to said first and second side walls of said direct cooking chamber, wherein said lid is rotatable between a closed position covering said second opening and an open position.

7. The cooking apparatus of claim 6, further comprising a protrusion joined to one of said side walls of said direct cooking chamber, wherein said first and second side walls of said direct cooking chamber comprise first and second slots, respectively, wherein said lid comprises first and second holes aligned with said first and second slots, respectively, wherein first and second fasteners are received by said aligned first and second holes and first and second slots, respectively, to rotatably join said lid to said first and second side walls, and wherein when said lid is in said open position said first and second fasteners are moveable within said first and second slots, respectively, between a locked position, in which said lid engages said protrusion to prevent said lid from moving to its closed position, and an unlocked position, in which said lid is moveable to its closed position.

8. The cooking apparatus of claim 1, wherein each of said plurality of vertically spaced shelves is adjustably supported by said first and second side walls and said rear wall such that each shelf is vertically moveable between a plurality of positions.

9. The cooking apparatus of claim 8, further comprising a pair of brackets corresponding with and supporting each of said plurality of vertically spaced shelves, wherein each of said pair of brackets is adjustably supported by said side walls and said rear wall such that said pair of brackets and corresponding shelf are vertically moveable between a plurality of positions.

10. The cooking apparatus of claim 9, wherein said first side wall comprises a plurality of vertically spaced slots, said second side wall comprises a plurality of vertically spaced slots, and said rear wall comprises a plurality of vertically spaced third slots and a plurality of vertically spaced fourth slots, wherein one bracket in each of said pair of brackets comprises a pair of protrusions that are operable to be received by said first and third slots, respectively, and the other bracket in each of said pair of brackets comprises a pair of protrusions that are operable to be received by said second and fourth slots, respectively.

11. The cooking apparatus of claim 9, wherein each of said shelves is operable to slide on said pair of brackets corresponding with said shelf, and wherein each of said shelves comprises a lock that is moveable between an unlocked position, in which said shelf may slide through said opening off of said brackets, and a locked position, in which said lock engages a portion of one of said brackets to prevent said shelf from sliding off of said brackets.

12. The cooking apparatus of claim 1, wherein said first and second doors comprise overlapping edges.

13. The cooking apparatus of claim 1, wherein said direct cooking chamber further comprises:
a front wall with an opening;
a removable ash pan operable to be received by said opening, wherein said ash pan comprises a slot; and
an ash pan lock rotatably joined to said front wall, wherein said ash pan lock is rotatable between a locked position, in which a portion of said ash pan lock is received by said slot to prevent movement of said ash pan, and an unlocked position.

14. The cooking apparatus of claim 13, wherein said ash pan comprises an intake vent, and said direct cooking chamber further comprises an intake valve that engages said ash pan and is moveable between a closed position blocking said intake vent and an open position allowing air flow through said intake vent, and wherein said top wall of said indirect cooking chamber comprises an exhaust vent, and said indirect cooking chamber further comprises an exhaust valve that engages said top wall and is moveable between a closed position blocking said exhaust vent and an open position allowing air flow through said exhaust vent.

15. The cooking apparatus of claim 13, wherein said direct cooking chamber further comprises a bottom wall that is joined with said front wall, and wherein said ash pan comprises a bottom surface with a plurality of ridges operable to slide over said bottom wall of said direct cooking chamber.

16. The cooking apparatus of claim 1, wherein said direct cooking chamber comprises:
a plurality of joined walls;
a charcoal grate supported by said joined walls; and
a grilling grate supported by said joined walls and positioned above said charcoal grate.

17. The cooking apparatus of claim 1, wherein said flange is operable to rest on a horizontal surface for supporting said direct and indirect cooking chambers.

18. The cooking apparatus of claim 1, wherein at least a portion of said indirect cooking chamber is positioned above said flange, and a portion of said direct cooking chamber is positioned below said flange.

19. The cooking apparatus of claim 18, wherein said joined walls of said indirect cooking chamber enclose an indirect cooking area that is positioned above said flange, and wherein said shelves are positioned within said indirect cooking area.

20. The cooking apparatus of claim 1, wherein said indirect cooking chamber comprises a height of between approximately 15 to 30 inches and a depth of between approximately 10 to 20 inches.

21. The cooking apparatus of claim 1, wherein said indirect cooking chamber comprises a height H and a depth D, and wherein the ratio of H to D is between approximately 1 to 3.

22. An outdoor cooking apparatus, comprising:
a direct cooking chamber;
an indirect cooking chamber joined to and extending at least partially upward and rearward from said direct cooking chamber, wherein said indirect cooking chamber comprises:
a plurality of joined walls enclosing an interior space,
a door that is moveably joined to at least one of said walls for accessing said interior space, and
a shelf positioned within said interior space and adjustably supported by at least one of said walls such that said shelf is vertically moveable within said interior space between a plurality of positions; and
a damper operable to regulate fluid flow between said direct and indirect cooking chambers.

23. The cooking apparatus of claim 22, wherein said plurality of joined walls comprises first and second side walls each joined with a top wall and a rear wall, wherein said joined walls present an opening opposite said rear wall, and wherein said shelf is adjustably supported by said first and second side walls and said rear wall.

24. The cooking apparatus of claim 23, further comprising first and second brackets that support said shelf, wherein said first and second brackets are adjustably supported by said first and second side walls, respectively, and said rear wall such that said brackets and shelf are vertically moveable within said interior space between a plurality of positions.

25. The cooking apparatus of claim 24, wherein said first side wall comprises a plurality of vertically spaced first slots, said second side wall comprises a plurality of vertically spaced second slots, and said rear wall comprises a plurality of vertically spaced third slots and a plurality of vertically spaced fourth slots, wherein said first bracket comprises a pair of protrusions that are operable to be received by said first and third slots, respectively, and wherein said second bracket comprises a pair of protrusions that are operable to be received by said second and fourth slots, respectively.

26. The cooking apparatus of claim 24, wherein said shelf is operable to slide on said brackets, and wherein said shelf comprises a lock that is moveable between an unlocked position, in which said shelf may slide through said opening off of said brackets, and a locked position, in which said lock engages a portion of one of said brackets to prevent said shelf from sliding off of said brackets.

27. The cooking apparatus of claim 22, wherein said indirect cooking chamber further comprises a plurality of vertically spaced shelves positioned within said interior space and adjustably supported by at least one of said walls such that each of said shelves is vertically moveable within said interior space between a plurality of positions.

28. An outdoor cooking apparatus, comprising:
a direct cooking chamber comprising:
first and second side walls each joined with rear, front, and bottom walls, wherein said joined walls present an opening opposite said bottom wall, wherein said first and second side walls comprise first and second slots, respectively,
a protrusion joined to one of said walls, and
a lid comprising first and second holes aligned with said first and second slots, respectively, wherein first and second fasteners are received by said aligned first and second holes and first and second slots, respectively, to rotatably join said lid to said first and second side walls, wherein said lid is moveable between a closed position in which it blocks said opening and an open position, and wherein when said lid is in said open position said first and second fasteners are moveable within said first and second slots, respectively, between a locked position, in which said lid engages said protrusion to prevent said lid from moving to its closed position, and an unlocked position, in which said lid is moveable to its closed position;
an indirect cooking chamber joined to and extending at least partially upward and rearward from said direct cooking chamber; and
a damper operable to regulate fluid flow between said direct and indirect cooking chambers.

29. The cooking apparatus of claim 28, wherein said protrusion is joined to one of said first and second side walls, and further comprising another protrusion joined to the other of said first and second side walls.
